(19) United States
(12) Patent Application Publication
(10) Pub. No.: US 2026/0288320 A1
(43) Pub. Date: Sep. 24, 2026

(54) MEDIA DATA GENERATION METHOD, APPARATUS, DEVICE, MEDIUM, AND PRODUCT

(71) Applicant: Beijing Zitiao Network Technology Co., Ltd., Beijing (CN)

(72) Inventors: Hantong XU, Beijing (CN); Shengru WANG, Beijing (CN); Chunliu ZHA, Beijing (CN); Jiecong HE, Beijing (CN)

(21) Appl. No.: 19/573,932

(22) Filed: Mar. 20, 2026

(30) Foreign Application Priority Data
Mar. 21, 2025 (CN) 202510345017.9

(51) Int. Cl. G06F 3/04845

(52) U.S. Cl. CPC G06F 3/04845

(57) ABSTRACT

Embodiments of the present disclosure provide a media data generation method and apparatus, a device, a medium, and a product. The method includes: displaying at least one first media data in a display page in response to receiving an operation of configuring the at least one first media data in a media data generation page; and displaying second media data in the display page in response to receiving event-related information of the second media data corresponding to the first media data; where the second media data includes text information and audio information corresponding to the text information, and the text information is related to media content of the first media data.

### CROSS-REFERENCE TO RELATED APPLICATION(S)

This application claims priority to Chinese Application No. 202510345017.9 filed on Mar. 21, 2025, the disclosure of which is incorporated herein by reference in its entirety.

### FIELD

Embodiments of the present disclosure relate to the field of computer processing technologies, and in particular, to a media data generation method and apparatus, a device, a medium, and a product.

### BACKGROUND

With the development of artificial intelligence technologies, more and more users use relevant media data production software to produce media data.

### SUMMARY

Embodiments of the present disclosure provide a media data generation method and apparatus, a device, a medium, and a product.

According to a first aspect, an embodiment of the present disclosure provides a media data generation method. The method includes: displaying at least one first media data in a display page in response to receiving an operation of configuring the at least one first media data in a media data generation page; and displaying second media data in the display page in response to receiving event-related information of the second media data corresponding to the first media data; where the second media data includes text information and audio information corresponding to the text information, and the text information is related to media content of the first media data.

According to a second aspect, an embodiment of the present disclosure further provides a media data generation apparatus. The apparatus includes: a first media data display module configured to display at least one first media data in a display page in response to receiving an operation of configuring the at least one first media data in a media data generation page; and a second media data display module configured to display second media data in the display page in response to receiving event-related information of the second media data corresponding to the first media data; where the second media data includes text information and audio information corresponding to the text information, and the text information is related to media content of the first media data.

According to a third aspect, an embodiment of the present disclosure further provides an electronic device. The electronic device includes: one or more processors; and a storage apparatus configured to store one or more programs, where the one or more programs, when executed by the one or more processors, cause the one or more processors to implement the media data generation method according to any one of the embodiments of the present disclosure.

According to a fourth aspect, an embodiment of the present disclosure further provides a storage medium including computer-executable instructions that, when executed by a computer processor, are configured to perform the media data generation method according to any one of the embodiments of the present disclosure.

According to a fifth aspect, an embodiment of the present disclosure further provides a computer program product, including a computer program that, when executed by a processor, implements the media data generation method according to any one of the embodiments of the present disclosure.

### BRIEF DESCRIPTION OF THE DRAWINGS

The above and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a media data generation method according to an embodiment of the present disclosure;

FIG. 2 is a schematic diagram representing second media data according to an embodiment of the present disclosure;

FIG. 3 is a schematic diagram representing a lyric component according to an embodiment of the present disclosure;

FIG. 4 is a schematic diagram representing an audio playback component according to an embodiment of the present disclosure;

FIG. 5 is a schematic flowchart of a media data generation method according to an embodiment of the present disclosure;

FIG. 6 is a schematic diagram of a media data generation method according to an embodiment of the present disclosure;

FIG. 7 is a schematic diagram representing a first page according to an embodiment of the present disclosure;

FIG. 8 is a schematic diagram representing an audio parameter setting interface according to an embodiment of the present disclosure;

FIG. 9 is a schematic diagram of a media data generation method according to an embodiment of the present disclosure;

FIG. 10 is a sequence diagram of generating media data according to an embodiment of the present disclosure;

FIG. 11 is a schematic structural diagram of a media data generation apparatus according to an embodiment of the present disclosure; and

FIG. 12 is a schematic structural diagram of an electronic device according to an embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that steps described in method implementations of the present disclosure may be performed in different orders, and/or performed in parallel. In addition, the method implementations may include additional steps and/or omit performing the illustrated steps. The scope of the present disclosure is not limited in this respect.

The term "include/comprise" and the like used herein are open-ended inclusions, that is, "include/comprise but not limited to". The term "based on" means "based at least partially on". The term "an embodiment" means "at least one embodiment". The term "another embodiment" means "at least one other embodiment". The term "some embodiments" means "at least some embodiments". Related definitions of other terms are given in the description below.

It should be noted that concepts such as "first" and "second" mentioned in the present disclosure are only used to distinguish between different apparatuses, modules, or units, and are not used to limit an order or interdependence of functions performed by these apparatuses, modules, or units.

It should be noted that the modifications of "a" and "a plurality of" mentioned in the present disclosure are illustrative rather than restrictive, and those skilled in the art should understand that unless otherwise clearly indicated in the context, they should be understood as "one or more".

The names of messages or information exchanged between a plurality of apparatuses in the implementations of the present disclosure are only used for illustrative purposes, and are not used to limit the scope of these messages or information.

It may be understood that before the technical solutions disclosed in the embodiments of the present disclosure are used, the user should be informed of the type, range of use, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, and the prompt information may be presented in text in the pop-up window. In addition, the pop-up window may also include a selection control for the user to select whether to "agree" or "disagree" to provide the personal information to the electronic device.

It may be understood that the above process of notifying and obtaining user authorization is only illustrative, and does not limit the implementations of the present disclosure, and other manners that satisfy the relevant laws and regulations may also be applied to the implementations of the present disclosure.

It may be understood that the data involved in the technical solution (including but not limited to the data itself, acquisition or use of the data) should comply with requirements of corresponding laws, regulations, and related provisions.

Most of the existing media data production software produces media data in manners of "image-to-image" or "image-to-video", and the like. The media data produced in such media production manners has relatively single content, and is difficult to satisfy user requirements.

Embodiments of the present disclosure provide a media data generation method and apparatus, a device, a medium, and a product to achieve a technical effect of improving the convenience of media data generation while improving the richness of content of generated media data to satisfy personalized requirements of users.

According to the technical solutions provided in the embodiments of the present disclosure, at least one first media data is displayed in a display page in response to receiving an operation of configuring the at least one first media data in a media data generation page; and second media data is displayed in the display page in response to receiving event-related information of the second media data corresponding to the first media data; where the second media data includes text information and audio information corresponding to the text information, and the text information is related to media content of the first media data. In this way, the problem in the prior art that the content of produced media data is single and difficult to satisfy production requirements of users is solved. After at least one first media data configured in a media data generation page is received, the at least one first media data is displayed in a display page, so that the first media data is visualized and it is convenient for a user to timely confirm whether the generated first media data satisfies a requirement. Further, when multimodal second media data corresponding to the first media data is received, text information in the second media data and audio information corresponding to the text information are displayed in the display page according to a preset form, so that the richness of the content of produced media data is improved, and the convenience of media data generation is also improved, thereby achieving the technical effect of satisfying personalized requirements of users.

Before the technical solutions provided in the embodiments of the present disclosure are described, an application scenario may be exemplarily described. The technical solutions provided in the embodiments of the present disclosure may be applied to any scenario in which media data needs to be generated. For example, in a development stage, a developer may develop a link for producing media data, and may integrate the link for producing media data into a functional module or an effect prop package. The functional module or the effect prop package may be deployed in any existing platform, application software, or tool that supports a function of generating media data, for a user to generate multimodal media data that meets personalized requirements of the user based on the deployed functional module or the deployed effect prop package.

In practical applications, if the user wants to obtain the media data that meets the requirements of the user, the user may trigger the functional module or the effect prop package provided in the embodiments of the present disclosure. After it is detected that the functional module or the effect prop package is triggered, a media data generation page corresponding to the embodiments of the present disclosure may be displayed, so that corresponding media data is generated based on an editing operation performed on the media data generation page.

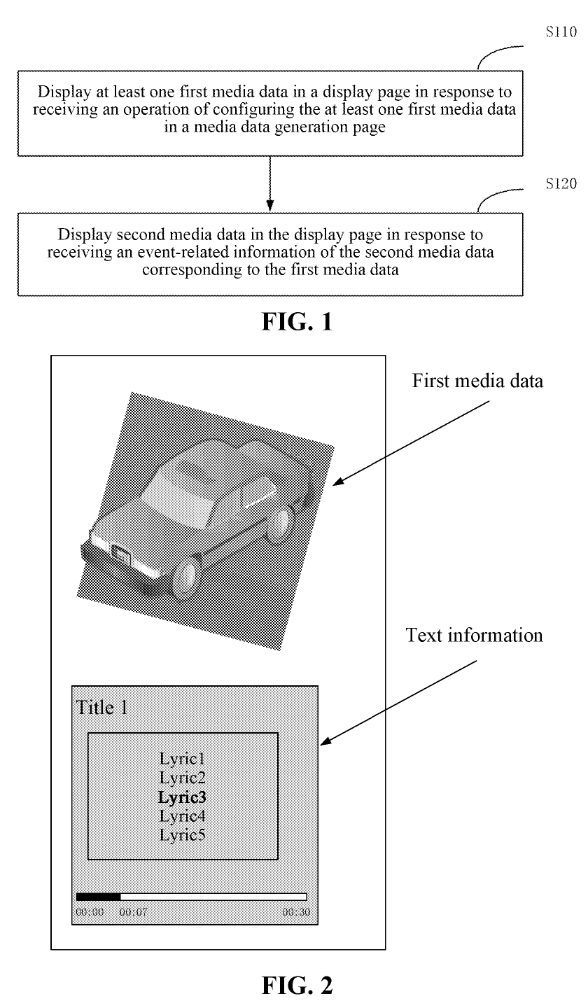

FIG. 1 is a schematic flowchart of a media data generation method according to an embodiment of the present disclosure. The embodiment of the present disclosure is applicable to any scenario in which media data needs to be generated. The method may be performed by a media data generation apparatus. The apparatus may be implemented in the form of software and/or hardware, or optionally, implemented by an electronic device. The electronic device may be a mobile terminal, a PC, a server, or the like.

As shown in FIG. 1, the method in this embodiment may specifically include the following steps.

S110: in response to receiving an operation of configuring at least one first media data in a media data generation page, the at least one first media data is displayed in a display page.

The media data generation page may be a page used to configure or edit the first media data. For example, the page may be an interface in a media data generation tool, software, a platform, or a similar application. Exemplarily, if the technical solutions provided in the embodiments of the present disclosure are integrated in a functional module or an effect prop package, when it is detected that the functional module or the effect prop package is triggered, a main interface corresponding to the functional module or the effect prop package may be displayed; and when it is detected that an image uploading or image capturing function in the main interface is triggered, the displayed page is the media data generation page. Alternatively, when it is detected that the functional module or the effect prop package is triggered, the displayed page is a capturing page or an image uploading page, and this page is used as the media data generation page. The first media data may refer to media content that is initially generated, edited, or configured, and the first media data is related to the media data that the user wants to obtain. For example, the first media data may be media data captured in real time, or may be media data that is obtained from a media database and uploaded. In this embodiment, the first media data may be one or a combination of multiple of a video, an image, a chart, an audio, and a text. The number of the first media data may be one or more. If multiple first media data exist, types of different first media data may be the same or may be different. The display page is used to display the first media data. For example, the display page may be a window page, a mask page, a pop-up window page, or the like in the media data generation page, or may be a new window page.

In this embodiment of the present disclosure, the at least one first media data may be edited in the media data generation page. After the configuration or editing operation for the first media data is completed, the system responds to this operation. In this case, the at least one configured first media data may be acquired, and the at least one configured first media data is displayed in the display page, so that the user may preview or perform a further operation on the media data, to obtain the final desired media data. It should be noted that a number range of media data may be preset. In this way, when the first media data is edited in the media data generation page, the number of the edited first media data is within the number range, for example, the number of the first media data is greater than 2 and less than 5. With this configuration, information overload caused by excessive data may be avoided while ensuring the richness and diversity of the generated media data, and prevent affecting the quality of the generated media.

S120: in response to receiving event-related information of the second media data corresponding to the first media data, the second media data is displayed in the display page.

The second media data is media data processed from the first media data. For example, the second media data may be media data that expands, supplements, or is derived from the first media data. Optionally, the second media data is music data corresponding to the first media data. The music data includes the text information and the audio information corresponding to the text information. The audio information may be audio used to describe the text information, or music or related sound effects used to reflect text content of the text information. The text information is related to the media content of the first media data. For example, the text information may be a description, an explanation, or a supplementary note for the first media data, or may be lyrics corresponding to the media content. The preset form may be a preconfigured form such as a layout, a style, a format, or an animation effect for displaying the second media data. For example, the preset form is as follows: the text information is displayed in a specific font, color, and layout; the audio information is displayed through a player control, and may include volume control, a pause/play button, and the like; and a display position of the audio information is next to the text information, below the text information, or the audio information is displayed in the form of a pop-up window.

In this embodiment of the present disclosure, after the at least one first media data is obtained, the first media data may be processed based on a client or a server, for example, the text information related to the media content of the first media data is added to the first media data, and the audio information corresponding to the text information is added to the first media data. The first media data obtained after the processing serves as the second media data. It should be noted that when the second media data is generated based on the client, the second media data may be directly displayed in the display page of the client according to the preset form. When the second media data is generated based on the server, the second media data may be sent by the server to the client. When receiving the second media data, the client may display the second media data in the display page according to the preset form, so that the user may intuitively see the display effect of the generated media data, and may also choose to view or play the displayed second media data based on the user’s needs.

Exemplarily, when the user interacts with the first media data (for example, performs an operation such as clicking or hovering), the system triggers an event and sends the first media data to the server, and enables the server to generate the second media data corresponding to the first media data. When the system receives the second media data returned by the server, the second media data may be displayed in the display page according to the preset form. For example, the text information in the second media data may be displayed in the form of a pop-up window, a sidebar, or an overlay, and the audio information may be automatically played or triggered to play by the user clicking a play button.

Optionally, the preset form includes a preset cover form and a preset text display form. Correspondingly, the second media data may be displayed in the display page according to the preset form in the following manners: at least one first media data in the second media data is displayed in the display page according to the preset cover form; the text information in the second media data is displayed in the display page according to the preset text display form; and when the audio information corresponding to the text information in the second media data is played, a first text corresponding to the played audio information is displayed in the text information in a first form.

The preset cover form may be a style and a layout for displaying the first media data (such as an image or a video clip) of the second media data, including but not limited to: a size, a shape, and a position of the cover, a style of an image or a video on the cover (for example, whether there is a border or whether a filter is added), an interaction manner of the cover (for example, playing the second media data by clicking the cover), and a display form (for example, displaying in the form of a 3D model or a 2D model). The preset text display form may be a display form for displaying the text information, including but not limited to: a text layout (for example, displaying next to the cover, below the cover, or in the form of a pop-up window), a style (for example, a font, a font size, a color, and typesetting), a format, an animation effect, an interaction manner of the text (for example, playing the second media data by clicking the text), and the like. The first form may be displayed through a player control, and may include volume control, a pause/play button, and the like.

In this embodiment of the present disclosure, the at least one first media data in the second media data may be displayed in the display page according to the preset cover form. For example, the first media data may be displayed in a carousel, and displayed in a floating window, a card at a fixed position, or a three-dimensional model. The text information in the second media data is displayed in the display page according to the preset text display form. For example, the text information may be a description, lyrics, a background story, or the like of the audio information. When an interaction operation (such as clicking the cover or the text, clicking a playing control, or hovering) is detected on the display page, the audio information corresponding to the text information in the second media data is played, and during playback of the audio information, the first text (such as the lyrics or voice-over text) corresponding to the played audio information is displayed in the text information in the first form (such as highlighting, changing color, and scrolling display). Exemplarily, referring to FIG. 2, the first media data is a cover image or a video clip of the second media data. The text information in the second media data is the lyrics or music introduction, and the audio information is a music file. The first media data in the second media data is displayed as the cover (displayed according to the preset cover form). The progress of playing the audio information may be adjusted by sliding the player, and the lyrics (that is, the text information) and the audio information are scrolled and played synchronously and highlighted.

It should be noted that after the second media data is acquired, the system may automatically play the second media data. Alternatively, the second media data may be saved as a music resource, and the audio information in the music resource is controlled to be played or the text information is controlled to be displayed by controlling the lyric component or the audio playback component. For example, after the cover is triggered, the audio information may be played. Alternatively, when the text information or a certain line of text in the text information is triggered, the audio information is played. Alternatively, when the playing control corresponding to the audio information is triggered, the audio information is played, and the lyrics are displayed on the display page in the preset text display form. For example, when the audio information is played, a currently played part of the lyrics (that is, the first text) may be highlighted, which enhances the audio-visual experience and helps the user better follow the content of the music playback.

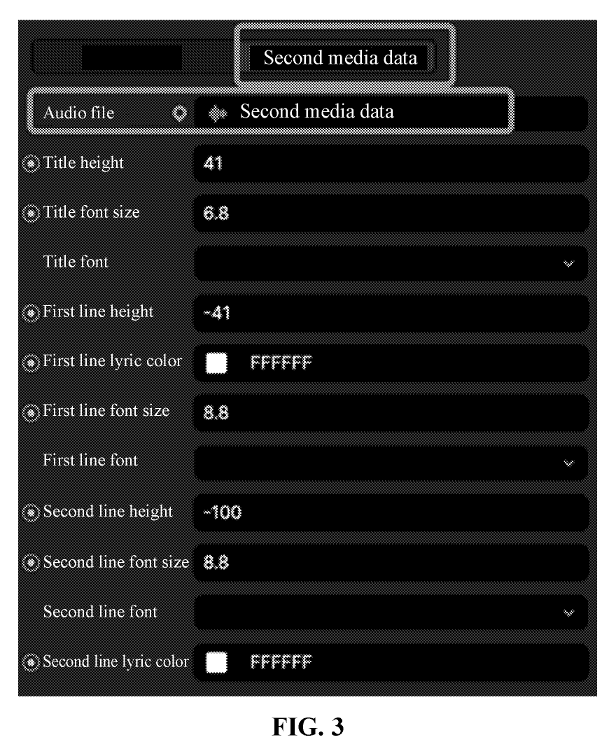

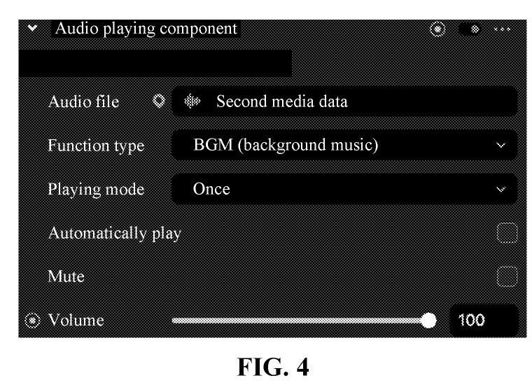

Exemplarily, the audio file of the second media data may be AI music, and a schematic diagram in which the second media data is associated with the lyric component may be found in FIG. 3. The lyric component may control parameters (such as a title height, a title font size, a title font, a first line height, a first line lyric color, a first line font size, a first line font, a second line height, a second line lyric color, a second line font size, and a second line font) of the played lyrics. The parameters may support modification or may not support modification, and the present disclosure is not limited thereto. A schematic diagram in which the second media data is associated with the audio playback component may be found in FIG. 4. The audio playback component may control parameters (such as a function type, a playing mode, whether to automatically play, whether to play silently, and a volume level) of the played audio information. The parameters may support modification or may not support modification, and the present disclosure is not limited thereto.

According to the technical solution provided in this embodiment of the present disclosure, the expression effect of the content of the second media data may be enhanced through the preset cover form and text display form. This improves the richness and professionalism of the content of the media data, and also facilitates the user to quickly understand the content of the second media data through the cover. The content of the media data is enriched through the synchronous display of the text and the audio, to satisfy the personalized requirements of the user. In addition, after the second media data is acquired, the second media data may be saved as the music resource, and the second media data is played by playing the music resource. This may effectively ensure the smoothness of the media data playback and avoid playback stuttering.

It should be noted that when the second media data is displayed, background information of the second media data may also be displayed according to preset background information; or at least one first media data in the second media data may be processed, for example, blurred or subjected to transparency and brightness adjustment, and the first media data obtained after the processing serves as the background information of the second media data. Still alternatively, the text information and the first media data may be fused to obtain the background information of the second media data; or the text information and the preset background information are fused to obtain the background information of the second media data.

To further enhance the display effect of the media data and make the display background match with the music data, background media data may be obtained according to a first style type corresponding to the second media data, and the background media data is configured to render the background information of the second media data.

The first style type may be used to represent a theme, a visual style, or the like of the second media data, for example, including but not limited to: vintage, modern, romantic, futuristic, happy, sad, inspiring, rock, jazz, electronic, minimalist, and the like. The background media data refers to media content used to render a background of the second media data. The background media data is related to the first style type of the second media data.

In this embodiment of the present disclosure, a style type of the second media data may be identified and used as the first style type. Then, the background media data matching the first style type may be obtained from a server or a database according to a preset mapping relationship or matching algorithm. For example, if the first style type of the second media data is "vintage", a vintage-style background image or video is selected as the background media data. Further, the background media data may be used as a background layer of the second media data, that is, when the system displays the second media data, a rendering technology may be used to render the background information of the second media data based on the obtained background media data, so that the background information may be combined with the text information and the audio information. It should be noted that to ensure that the display of the background media data does not interfere with the display of the second media data (the text information and the audio information), attribute information such as brightness and transparency of the background media data may be dynamically adjusted based on the text information and the audio information. The background information for displaying the second media data is rendered by introducing the background media data matching the first style type, so that the visual effect of the second media data may be enhanced, the display of the second media data becomes more vivid, and the user experience is improved. In addition, different style types may correspond to different background media data, which may implement personalized media data production and satisfy requirements of different users.

According to the technical solution provided in this embodiment of the present disclosure, at least one first media data is displayed in a display page in response to receiving an operation of configuring the at least one first media data in a media data generation page; and second media data is displayed in the display page in response to receiving event-related information of the second media data corresponding to the first media data; where the second media data includes text information and audio information corresponding to the text information, and the text information is related to media content of the first media data. In this way, the problem in the prior art that the content of produced media data is single and difficult to satisfy production requirements of users is solved. In response to receiving at least one first media data configured in a media data generation page, the at least one first media data is displayed in a display page, so that the first media data is visualized and it is convenient for a user to timely confirm whether the generated first media data satisfies a requirement. Further, when second media data corresponding to the first media data is received, text information in the second media data and audio information corresponding to the text information are displayed in the display page according to a preset form, so that the richness of the content of generated media data is improved, and the convenience of media data generation is also improved, thereby achieving the technical effect of satisfying personalized requirements of users.

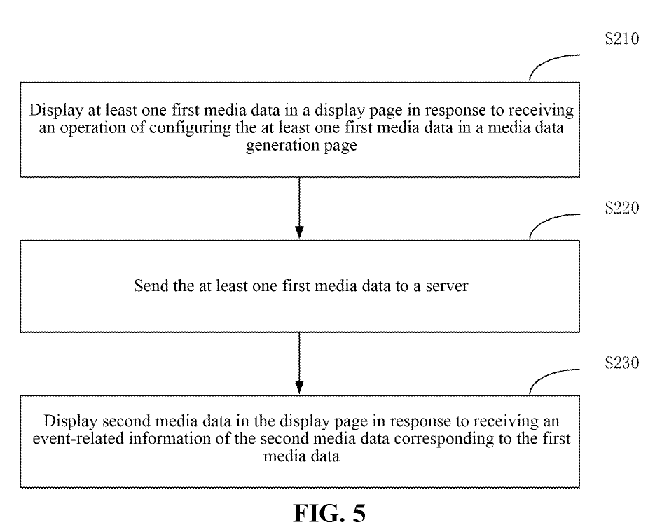

FIG. 5 is a schematic flowchart of a media data generation method according to an embodiment of the present disclosure. In the technical solution of this embodiment, based on the preceding embodiment, after the at least one first media data is displayed, the at least one first media data may be sent to a server, so that the second media data is obtained by the server according to audio parameter information and the at least one first media data. For specific implementations, refer to the detailed description of the embodiments of the present disclosure. Technical features the same as or similar to those in the preceding embodiment are not described herein again.

As shown in FIG. 5, the method in this embodiment may specifically include the following steps.

S210: in response to receiving an operation of configuring at least one first media data in a media data generation page, the at least one first media data is displayed in a display page.

S220: the at least one first media data is sent to a server.

In this embodiment of the present disclosure, the first media data may be edited or uploaded on a client (such as a webpage or a mobile application). Then, the at least one first media data may be sent to the server through an interface, remote transmission, HTTP/HTTPS, WebSocket, or another communication protocol, so that second media data corresponding to the first media data is obtained by the server according to the at least one first media data and preconfigured audio parameter information. The server is configured to generate the second media data. The audio parameter information may be a parameter used to guide how to generate or select audio content matching the first media data according to the first media data. For example, the audio parameter information may be a music style (such as rock, jazz, and classical), a music rhythm (such as fast rhythm and slow rhythm), music emotion (such as happy, sad, and inspiring), an audio format (such as MP3 and WAV), an audio length, and the like. The second media data is media data generated based on the first media data and the audio parameter information.

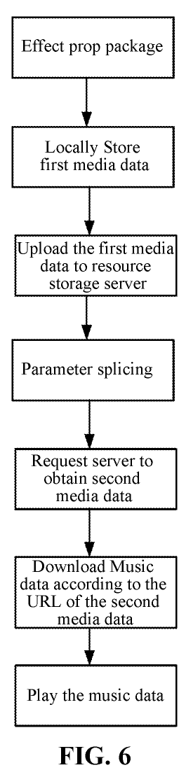

Specifically, after receiving the at least one first media data, the server may obtain, from a database based on a feature (such as a content type, a theme, and emotion) of the first media data and the preconfigured audio parameter information, the second media data matching the first media data. Alternatively, audio information is generated using a machine learning model or an algorithm engine according to the at least one first media data and the audio parameter information. Then, a text description or lyrics matching the audio information may be generated using a natural language generation technology and used as text information, to obtain the audio information and the text information in the second media data. Alternatively, a third-party audio service is invoked to acquire adapted second media data. Further, the server may send the second media data back to the client, so that the client receives the second media data and displays the second media data in the display page according to a preset form. Exemplarily, referring to FIG. 6, a user may select an effect prop package and configure at least one first media data. After the first media data input by the user is locally acquired, the first media data is saved and uploaded to a resource storage server (such as a cloud). The resource storage server returns a URL link of the first media data, and the client splices media data request parameters and sends the parameters to a cloud editing server, to request to acquire the second media data. The cloud editing server requests an image-to-text server (that is, a text conversion server) and an audio server respectively, to obtain a URL link of the second media data. The client may download music data based on the URL link of the second media data and play the music data.

The advantage of such a configuration is that the client only needs to upload the first media data, and the server is responsible for generating the second media data matching the first media data. This relieves the processing pressure of the client, and may also improve the data processing efficiency and improve the user experience.

In this embodiment of the present disclosure, after the at least one first media data is displayed, the at least one first media data may be sent to the server, so that the first style type of the first media data is obtained by the server based on analysis and processing of the at least one first media data, where the first style type is a type of at least one preset second style type; and the audio parameter information corresponding to the first style type is obtained by the server, so that the second media data is obtained based on the audio parameter information and the at least one first media data.

It may be understood that after the at least one first media data is sent to the server, the server may use an algorithm to analyze and process the at least one first media data, and an analysis and processing method may be related to a data type of the first media data. For example, for the first media data in a form of an image or a video, a style type of the first media data is identified using an image recognition technology; for the first media data in a form of text content, emotion or a theme of the first media data is analyzed using a text analysis technology; and for the first media data in a form of audio content, features such as a rhythm and a tone of the first media data are analyzed using an audio analysis technology. The first style type matching the first media data is obtained from the at least one second style type based on an analysis result. Further, the server may obtain the audio parameter information matching the first style type from a database or a storage. For example, the audio parameter information corresponding to different style types may be preconfigured, and there is a mapping relationship. The audio parameter information mapped to the first style type may be obtained by using the first style type as a key value, so that the server may obtain the second media data based on the audio parameter information and the at least one first media data. The advantage of such a configuration is that the first style type of the first media data is analyzed, so that the style type of the generated second media data is the same as or similar to the style type of the first media data input by the user, and the style type of the second media data is matched with the personalized requirements of the user. This satisfies the personalized requirements of the user, and also improves the user experience.

Exemplarily, the first media data includes two images uploaded by the user, and the first style type of the first media data is jazz. The server generates jazz-style background music and lyrics based on the audio parameter information matching the style type "jazz" and the first media data.

In this embodiment of the present disclosure, obtaining, by the server based on analysis and processing of the at least one first media data, the first style type of the first media data includes: performing style type analysis on the at least one input first media data based on a style type determination model deployed in the server, to output the first style type of the first media data; or obtaining, based on third media data corresponding to the at least one second style type that is deployed in the server, a similarity attribute between the third media data and each of the at least one first media data; and obtaining the first style type of the first media data based on the similarity attribute.

The style type determination model may be a pre-trained model used to obtain a style type of media data. For example, the style type determination model may be an image recognition model used to perform style classification on an image or a video frame, or a text analysis model used to perform style classification on text content, or an audio analysis model used to perform style classification on audio content. The third media data is media data that is pre-stored in the server and corresponds to the second style type. The similarity attribute is used to characterize a similarity between pieces of media data. For example, a larger value of the similarity attribute represents higher similarity between two pieces of media data; in contrast, a smaller value of the similarity attribute represents lower similarity between two pieces of media data.

In practical applications, the first style type of the first media data may be obtained by two different methods, and the two methods are both deployed in the server. One method may be: a style type determination model may be obtained through training in advance by using a media data sample marked with a style type. The server inputs the at least one first media data into the pre-trained style type determination model, and the style type of the first media data is output, to obtain the first style type of the first media data. Another method may be: performing similar feature analysis on the third media data corresponding to the at least one second style type deployed in the server and each of the first media data, using a similarity analysis algorithm (such as cosine similarity, Euclidean distance, and Jaccard similarity), for example, analyzing a similarity between features such as colors, textures, and compositions of images, to obtain the similarity attribute between each piece of third media data and each piece of first media data. The second style type of the third media data corresponding to a maximum value of the similarity attribute may be used as the first style type of the first media data. Alternatively, the number of third media data belonging to the same second style type is obtained, and the second style type corresponding to a maximum value of the number may be used as the first style type of the first media data. Alternatively, third media data corresponding to a similarity attribute greater than a preset threshold may be selected, and on the basis of the selected third media data, the number of third media data belonging to the same second style type is obtained, and the second style type corresponding to a maximum value of the number is used as the first style type of the first media data. Certainly, the first style type of the first media data may also be obtained by combining style types obtained by the two methods. The first style type of the first media data is obtained by different methods, so that not only the accuracy of style type determination may be ensured, but also the second media data may be obtained based on the audio parameter information corresponding to the first style type and the at least one first media data, so that the style type of the second media data is matched with the personalized requirements of the user.

Optionally, the audio parameter information includes a first model used to obtain the text information corresponding to the first media data, fourth media data corresponding to the text information, and a music style type of the second media data. The first model may be a pre-trained model used to obtain the text information corresponding to the media data. The fourth media data may be a predetermined text (such as a word or a phrase), and is auxiliary media data used to guide the generation of the text information in the second media data. The fourth media data is media data included in the text information. The music style type is related to the first style type. The music style type may be a predefined music style type, such as classical, rock, jazz, and electronic.

In this embodiment of the present disclosure, obtaining the second media data based on the at least one first media data and the audio parameter information includes: inputting the at least one first media data and the fourth media data into the first model to perform text conversion processing, to obtain the text information corresponding to the at least one first media data; performing orchestration processing on the text information based on the music style type, to obtain the audio information corresponding to the text information; and obtaining the second media data based on the text information, the audio information, and the at least one first media data.

Specifically, the first model may be obtained through pre-training based on a media data sample marked with text content, so that the first model has a function of generating the text information matching the input media data. The trained first model is deployed in the server. The server may input the at least one first media data and the fourth media data in the audio parameter information into the first model, and the first model performs text conversion processing on the input first media data and the input fourth media data, to generate the text information matching the at least one first media data. For example, the first model may be an image-to-text model based on image recognition and natural language generation technologies, and the first model may process the first media data such as an image or a video frame into a descriptive text or lyrics, to obtain the text information. Alternatively, the first model may be an audio-to-text model based on a speech recognition technology, and the first model may convert the first media data such as audio content into the text information. Alternatively, the first model may be a text-to-text model based on a natural language processing technology, and the first model may rewrite or expand the first media data in a form of text to obtain the text information. Further, the music style type and the text information may be input into a pre-trained audio generation model, and the audio generation model performs orchestration processing on the text information according to the music style type, and outputs the audio information corresponding to the text information. Alternatively, an audio service is invoked, and based on the audio service, orchestration processing is performed on the text information according to the music style type, and the audio information is output. The text information, the audio information, and the at least one first media data are integrated to obtain the second media data. According to the technical solution provided in this embodiment of the present disclosure, the first model for text generation and the audio generation technology are combined to generate rich multimodal media data content, so that the richness of the second media data is enhanced and the personalized requirements of the user are also satisfied.

In this embodiment of the present disclosure, the audio parameter information may be obtained in the following manners: an audio parameter setting interface is displayed in response to a trigger operation on an audio generation control in a first page; and in response to an edit operation in the audio parameter setting interface, a quantity range, a first model, a first style type, and fourth media data for configuring at least one first media data in the audio parameter information are obtained.

The first page includes the audio generation control. The audio generation control refers to a visual control used to trigger entry into the audio parameter setting interface. The audio parameter setting interface includes at least one selectable second style type, and allows the user to configure related parameters for generating the second media data in the interface. That is, the second style type is a style type available for selection by the user, and the first style type is a style type actually selected by the user. The number range is used to limit the number of the configured first media data. For example, the number range is "greater than 2 and less than 5".

Specifically, the audio generation control may be developed in the first page in advance. In this way, when the user triggers the audio generation control or uses a keyboard to press a shortcut key of the audio generation control, it is considered that the trigger operation on the audio generation control is detected. In this case, the audio parameter setting interface may be displayed, and the audio parameter setting interface provides a function of editing the audio parameter information. Exemplarily, the audio parameter setting interface includes a number range input box that allows the user to input or select a number range, a model selection drop-down menu that supports the user to select the first model, a style type selector that supports the user to select a style type, a component that supports the user to upload or select the fourth media data, and the like. The user may edit and input the number range of the first media data in the audio parameter setting interface, select the first model for the text conversion processing, select the first style type of the first media data from the preset second style type, and edit and input the audio parameter information such as the fourth media data. After the edit operation is completed, a "Confirm" button or a "Save" button may be triggered. The system responds to this operation, and saves the configured audio parameter information, so that the server may obtain the audio parameter information corresponding to the first style type, to obtain the second media data based on the audio parameter information and the at least one first media data.

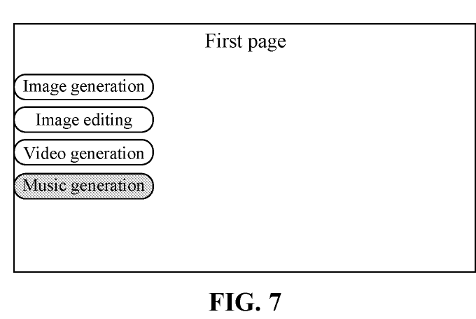

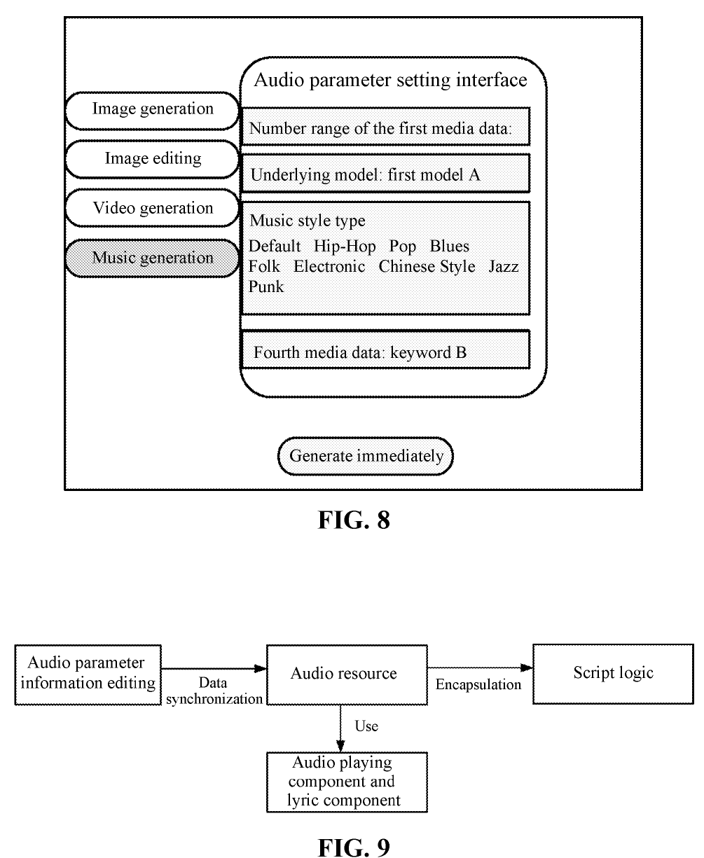

Exemplarily, referring to FIG. 7, a "Music generation" button (that is, the audio generation control) in the first page may be clicked to display the audio parameter setting interface, and a schematic diagram of the audio parameter setting interface may be found in FIG. 8. An underlying model (such as the first model A) may be set in the audio parameter setting interface, a music style type (such as pop) is selected, and the fourth media data (such as a keyword B) is set. Referring to FIG. 9, after the audio parameter information is set, the audio parameter information is synchronized to an audio resource, and the audio server is requested to generate an audio resource of the second media data. The generated second media data may be acquired by making a request and displayed. In addition, the second media data may also be encapsulated as script logic (that is, generation flow for the second media data) in a form of an audio resource, and the audio resource may be referenced by another component (including the audio playback component and the lyric component) that uses an audio file.

According to the technical solution provided in this embodiment of the present disclosure, the audio parameter information may be customized, which satisfies different media data production requirements, thereby facilitating dynamic adjustment of the audio parameter information (that is, adjustment of audio generation and processing logic) based on different requirements, thereby improving the convenience and efficiency of media data production.

S230: in response to receiving event-related information of the second media data corresponding to the first media data, the second media data is displayed in the display page according to a preset form.

According to the technical solution provided in this embodiment of the present disclosure, after the at least one first media data is displayed, the at least one first media data is sent to the server, so that the server may generate the multimodal second media data corresponding to the first media data according to the at least one first media data and the preconfigured audio parameter information. In this way, the content richness of the second media data is enhanced, the processing pressure of the client is relieved, the data processing efficiency is improved, and the user experience is improved.

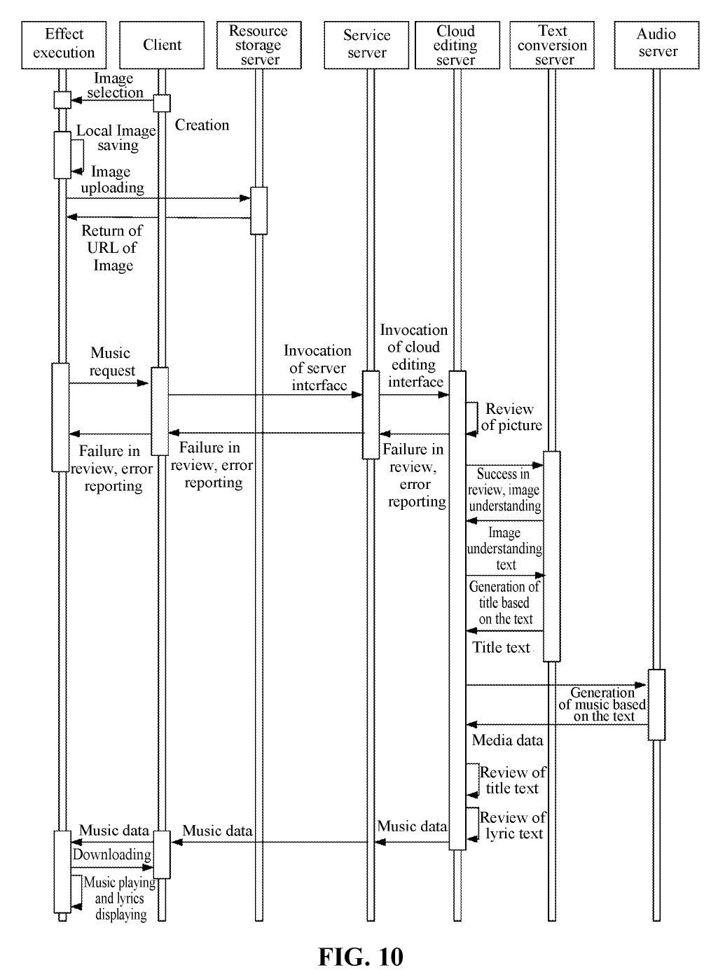

As an optional embodiment of the preceding embodiments, FIG. 10 is a sequence diagram of media data generation according to an embodiment of the present disclosure. To help those skilled in the art further understand the technical solution of this embodiment of the present disclosure, a specific application scenario example is given below. For details, refer to the following specific content.

The user may invoke an effect runtime (that is, the functional module or the effect prop package) on the client to select an image (that is, the first media data). After the image is selected, the effect runtime locally saves the image, and uploads the selected image to the resource storage server to save. The resource storage server returns a URL link of the image. The effect runtime requests the client to generate music (that is, requests to generate the second media data). The client invokes an interface of a service server, and the service server invokes an interface of the cloud editing server. The cloud editing server reviews the compliance of the image. If the review fails, an error is reported, and prompt information indicating that the review fails and an error occurs is sent to the service server. The service server then feeds back the prompt information indicating that the review fails and the error occurs to the client, and the client then returns the prompt information to the effect runtime. If the review succeeds, the image is sent to the text conversion server, and the text conversion server performs image understanding and generates an image understanding text (that is, information in the text information). The text conversion server sends the image understanding text to the cloud editing server. The cloud editing server requests the text conversion server to generate a title, and the text conversion server generates a title text (that is, information in the text information) based on the image understanding text and returns the title text to the cloud editing server. The cloud editing server sends the image understanding text to the audio server, and the audio server generates music (that is, the audio information) based on the image understanding text. The audio server sends media data such as the music and lyrics to the cloud editing server. The cloud editing server reviews the compliance of the title text and a lyric text. If the review succeeds, music data (that is, the second media data, including the title text, the lyric text, and the music) is sent to the service server, and the service server then sends the music data to the client. The client sends the music data to the effect runtime, and the effect runtime downloads the music data to the client, plays the music, and displays the lyrics.

According to the technical solution provided in this embodiment of the present disclosure, after at least one first media data configured in a media data generation page is received, the at least one first media data is displayed in a display page, so that the first media data is visualized and it is convenient for a user to timely confirm whether the generated first media data satisfies a requirement. Further, when second media data corresponding to the first media data is received, text information in the second media data and audio information corresponding to the text information are displayed in the display page according to a preset form, so that the richness of the content of generated media data is improved, and the convenience of media data generation is also improved, thereby achieving the technical effect of satisfying personalized requirements of users.

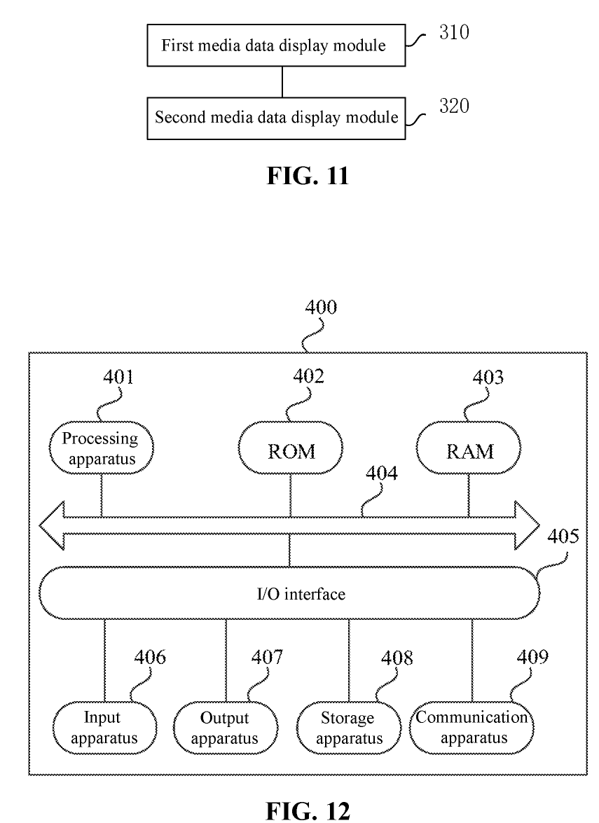

FIG. 11 is a schematic diagram of a structure of a media data generation apparatus according to an embodiment of the present disclosure. As shown in FIG. 11, the apparatus includes: a first media data display module 310 and a second media data display module 320.

The first media data display module 310 is configured to display at least one first media data in a display page in response to receiving an operation of configuring the at least one first media data in a media data generation page; and the second media data display module 320 is configured to display second media data in the display page in response to receiving event-related information of the second media data corresponding to the first media data; where the second media data includes text information and audio information corresponding to the text information, and the text information is related to media content of the first media data.

Based on the preceding apparatuses, optionally, the apparatus further includes: a first media data sending unit configured to send the at least one first media data to a server, so that the second media data corresponding to the first media data is obtained by the server according to the at least one first media data and preconfigured audio parameter information.

Based on the preceding apparatuses, optionally, the apparatus further includes: a second media data sending unit configured to send the at least one first media data to a server, so that a first style type of the first media data is obtained by the server based on analysis and processing of the at least one first media data, where the first style type is a type of at least one preset second style type; and audio parameter information corresponding to the first style type is obtained by the server, to obtain the second media data based on the audio parameter information and the at least one first media data.

Based on the preceding apparatuses, optionally, the server is configured to perform style type analysis on the at least one input first media data based on a style type determination model deployed in the server, and output the first style type of the first media data; or obtain similarity attributes between third media data corresponding to the at least one second style type deployed in the server and the at least one first media data, respectively; and obtain the first style type of the first media data based on the similarity attributes.

Based on the preceding apparatuses, optionally, the audio parameter information includes a first model used to obtain the text information corresponding to the first media data, fourth media data corresponding to the text information, and a music style type of the second media data; where the fourth media data is media data included in the text information, and the music style type is related to the first style type.

Based on the preceding apparatuses, optionally, the server is configured to input the at least one first media data and the fourth media data into the first model to perform text conversion processing, to obtain the text information corresponding to the at least one first media data; perform orchestration processing on the text information based on the music style type, to obtain the audio information corresponding to the text information; and obtain the second media data based on the text information, the audio information, and the at least one first media data.

Based on the preceding apparatuses, optionally, the preset form includes a preset cover form and a preset text display form, and the second media data display module 320 includes: a cover display unit configured to display at least one first media data in the second media data in the display page according to the preset cover form; a text information display unit configured to display the text information in the second media data in the display page according to the preset text display form; and a playing unit configured to, when playing audio information corresponding to the text information in the second media data, display a first text corresponding to the playing audio information in the text information in a first form.

Based on the preceding apparatuses, optionally, the apparatus further includes: a background information display unit configured to obtain background media data according to the first style type corresponding to the second media data, the background media data being configured to render background information of the second media data.

Based on the preceding apparatuses, optionally, the apparatus further includes: an audio parameter setting interface display unit configured to display an audio parameter setting interface in response to a trigger operation on an audio generation control in a first page; and an audio parameter information obtaining unit configured to obtain, in response to an edit operation in the audio parameter setting interface, a quantity range, a first model, a first style type, and fourth media data for configuring at least one first media data in the audio parameter information, where the audio parameter setting interface includes at least one selectable second style type.

Based on the preceding apparatuses, optionally, the second media data is music data corresponding to the first media data.

According to the technical solution of this embodiment of the present disclosure, at least one first media data is displayed in a display page in response to receiving an operation of configuring the at least one first media data in a media data generation page; and second media data is displayed in the display page in response to receiving event-related information of the second media data corresponding to the first media data; where the second media data includes text information and audio information corresponding to the text information, and the text information is related to media content of the first media data. In this way, the problem in the prior art that the content of produced media data is single and difficult to satisfy production requirements of users is solved. After at least one first media data configured in a media data generation page is received, the at least one first media data is displayed in a display page, so that the first media data is visualized and it is convenient for a user to timely confirm whether the generated first media data satisfies a requirement. Further, when second media data corresponding to the first media data is received, text information in the second media data and audio information corresponding to the text information are displayed in the display page according to a preset form, so that the richness of the content of generated media data is improved, and the convenience of media data generation is also improved, thereby achieving the technical effect of satisfying personalized requirements of users.

The media data generation apparatus provided in this embodiment of the present disclosure may perform the media data generation method provided in any embodiment of the present disclosure, and has corresponding functional modules and beneficial effects for performing the method.

It is worth noting that the units and modules included in the preceding apparatus are just divided according to functional logic but are not limited to such division, as long as corresponding functions may be implemented. Additionally, the specific names of the functional units are just for distinguishing between each other but not to limit the protection scope of the embodiments of the present disclosure.

FIG. 12 is a schematic diagram of a structure of an electronic device according to an embodiment of the present disclosure. As shown in FIG. 12, the electronic device 400 may include a processing apparatus (such as a central processing unit and a graphics processing unit) 401 that may perform various appropriate actions and processing according to a program stored in a read-only memory (ROM) 402 or a program loaded from a storage apparatus 408 into a random access memory (RAM) 403. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatuses may be connected to the I/O interface 405: an input apparatus 406 including, for example, a touch screen, a touchpad, a keyboard, a mouse, a camera, a microphone, an accelerometer, and a gyroscope; an output apparatus 407 including, for example, a liquid crystal display (LCD), a speaker, and a vibrator; the storage apparatus 408 including, for example, a magnetic tape and a hard disk; and a communication apparatus 409. The communication apparatus 409 may allow the electronic device 400 to be in wireless or wired communication with other devices to exchange data. Although FIG. 12 shows the electronic device 400 having various apparatuses, it should be understood that it is not required to implement or provide all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network via the communication apparatus 409, or installed from the storage apparatus 408, or installed from the ROM 402. When the computer program is executed by the processing apparatus 401, the preceding functions defined in the method of the embodiments of the present disclosure are executed.

The names of messages or information exchanged between a plurality of apparatuses in the implementations of the present disclosure are only used for illustrative purposes, and are not used to limit the scope of these messages or information.

The electronic device provided in this embodiment of the present disclosure belongs to the same inventive concept as the media data generation method provided in the preceding embodiments. For technical details not described in detail in this embodiment of the present disclosure, reference may be made to the preceding embodiments, and this embodiment has the same beneficial effects as the preceding embodiments.

An embodiment of the present disclosure provides a computer storage medium having a computer program stored thereon, where the program, when executed by a processor, implements the media data generation method provided in the preceding embodiments.

It should be noted that the preceding computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, where the program may be used by or used in conjunction with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in conjunction with an instruction execution system, apparatus, or device. The program code contained in the computer-readable medium may be transmitted in any suitable medium, including but not limited to a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs that, when executed by the electronic device, cause the electronic device to: display at least one first media data in a display page in response to receiving an operation of configuring the at least one first media data in a media data generation page; and display second media data in the display page in response to receiving event-related information of the second media data corresponding to the first media data; where the second media data includes text information and audio information corresponding to the text information, and the text information is related to media content of the first media data.

The computer program code for performing the operations of the present disclosure may be written in one or more programming languages or combination thereof, the programming languages including but not limited to object-oriented programming languages such as Java, Smalltalk, and C++, as well as conventional procedural programming languages such as "C" language or similar programming languages. The program code may be executed entirely on a computer of a user, partly on the computer of the user, as a stand-alone software package, partly on the computer of the user and partly on a remote computer, or entirely on the remote computer or a server. In the scenario involving the remote computer, the remote computer may be connected to the computer of the user through any kind of network, including a local area network (LAN) or a wide area network (WAN), or may be connected to an external computer (for example, connected via the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented by software or by hardware. The name of the unit does not constitute a limitation on the unit itself under certain circumstances. For example, the first acquisition unit may also be described as a "unit for acquiring at least two internet protocol addresses".

The functions described above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The preceding description is merely illustration of the preferred embodiments of the present disclosure and the technical principles employed. Those skilled in the art should understand that the scope of disclosure involved in the present disclosure is not limited to the technical solutions formed by the specific combination of the preceding technical features, and should also cover other technical solutions formed by any combination of the preceding technical features or equivalent features thereof without departing from the preceding concept of disclosure. For example, the preceding features and the technical features disclosed in the present disclosure (but not limited thereto) and having similar functions are replaced each other to form a technical solution.

In addition, although the operations are depicted in a particular order, it should not be understood as requiring these operations to be performed in the particular order shown or in sequential order. Under certain circumstances, multitasking and parallel processing may be advantageous. Similarly, although the preceding discussion contains several specific implementation details, these should not be construed as limitations on the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are merely exemplary forms for implementing the claims.

I/We Claim:

1. A media data generation method, comprising:
displaying at least one first media data in a display page in response to receiving an operation of configuring the at least one first media data in a media data generation page; and
displaying second media data in the display page in response to receiving event-related information of the second media data corresponding to the first media data;
wherein the second media data comprises text information and audio information corresponding to the text information, and the text information is related to media content of the first media data.

2. The method of claim 1, wherein after displaying the at least one first media data, the method further comprises:
sending the at least one first media data to a server, to obtain, by the server, the second media data corresponding to the first media data according to the at least one first media data and preconfigured audio parameter information.

3. The method of claim 1, wherein after displaying the at least one first media data, the method further comprises:
sending the at least one first media data to a server, to obtain a first style type of the first media data based on analysis and processing of the at least one first media data by the server, wherein the first style type is a type of at least one preset second style type; and
obtaining audio parameter information corresponding to the first style type by the server, to obtain the second media data based on the audio parameter information and the at least one first media data.

4. The method of claim 3, wherein obtaining the first style type of the first media data based on the analysis and processing of the at least one first media data by the server comprises:
performing style type analysis on the input at least one first media data based on a style type determination model deployed in the server, and outputting the first style type of the first media data; or
obtaining, based on third media data corresponding to the at least one second style type deployed in the server, similarity attributes between the third media data and the at least one first media data, respectively; and
obtaining the first style type of the first media data based on the similarity attributes.

5. The method of claim 2, wherein the audio parameter information comprises a first model configured to obtain text information corresponding to the first media data, fourth media data corresponding to the text information, and a music style type of the second media data;
wherein the fourth media data is media data comprised in the text information, and the music style type is related to the first style type.

6. The method of claim 5, wherein obtaining the second media data based on the at least one first media data and the audio parameter information comprises:
inputting the at least one first media data and the fourth media data into the first model to perform text conversion processing, to obtain the text information corresponding to the at least one first media data;
performing orchestration processing on the text information based on the music style type, to obtain the audio information corresponding to the text information; and
obtaining the second media data based on the text information, the audio information, and the at least one first media data.

7. The method of claim 6, wherein the preset form comprises a preset cover form and a preset text display form, and displaying the second media data in the display page according to the preset form comprises:
displaying at least one first media data in the second media data in the display page according to the preset cover form;
displaying the text information in the second media data in the display page according to the preset text display form; and
in response to playing the audio information corresponding to the text information in the second media data, displaying a first text corresponding to the played audio information in the text information in a first form.

8. The method of claim 1, further comprising:
obtaining background media data according to a first style type corresponding to the second media data, the background media data being configured to render background information of the second media data.

9. The method of claim 2, further comprising:
displaying an audio parameter setting interface in response to a trigger operation on an audio generation control in a first page; and
obtaining, in response to an edit operation in the audio parameter setting interface, a quantity range, a first model, a first style type, and fourth media data for configuring at least one first media data in the audio parameter information, wherein the audio parameter setting interface comprises at least one selectable second style type.

10. The method of claim 1, wherein the second media data is music data corresponding to the first media data.

11. An electronic device, wherein the electronic device comprises:
one or more processors; and
a storage configured to store one or more programs,
wherein the one or more programs, when executed by the one or more processors, cause the one or more processors to:
display at least one first media data in a display page in response to receiving an operation of configuring the at least one first media data in a media data generation page; and
display second media data in the display page in response to receiving event-related information of the second media data corresponding to the first media data;
wherein the second media data comprises text information and audio information corresponding to the text information, and the text information is related to media content of the first media data.

12. The electronic device of claim 11, wherein after the one or more programs cause the one or more processors to display the at least one first media data, the one or more programs further cause the one or more processors to:
send the at least one first media data to a server, to obtain, by the server, the second media data corresponding to the first media data according to the at least one first media data and preconfigured audio parameter information.

13. The electronic device of claim 11, wherein after the one or more programs cause the one or more processors to display the at least one first media data, the one or more programs further cause the one or more processors to:
send the at least one first media data to a server, to obtain a first style type of the first media data based on analysis and processing of the at least one first media data by the server, wherein the first style type is a type of at least one preset second style type; and
obtain audio parameter information corresponding to the first style type by the server, to obtain the second media data based on the audio parameter information and the at least one first media data.

14. The electronic device of claim 13, wherein the one or more programs causing the one or more processors to obtain the first style type of the first media data based on the analysis and processing of the at least one first media data by the server further cause the one or more processors to:
perform style type analysis on the input at least one first media data based on a style type determination model deployed in the server, and output the first style type of the first media data; or
obtain, based on third media data corresponding to the at least one second style type deployed in the server, similarity attributes between the third media data and the at least one first media data, respectively; and
obtain the first style type of the first media data based on the similarity attributes.

15. The electronic device of claim 12, wherein the audio parameter information comprises a first model used to obtain text information corresponding to the first media data, fourth media data corresponding to the text information, and a music style type of the second media data;
wherein the fourth media data is media data comprised in the text information, and the music style type is related to the first style type.

16. The electronic device of claim 15, wherein the one or more programs causing the one or more processors to obtain the second media data based on the at least one first media data and the audio parameter information further cause the one or more processors to:
input the at least one first media data and the fourth media data into the first model to perform text conversion processing, to obtain the text information corresponding to the at least one first media data;
perform orchestration processing on the text information based on the music style type, to obtain the audio information corresponding to the text information; and
obtain the second media data based on the text information, the audio information, and the at least one first media data.

17. The electronic device of claim 16, wherein the preset form comprises a preset cover form and a preset text display form, and the one or more programs causing the one or more processors to display the second media data in the display page according to the preset form further cause the one or more processors to:
display at least one first media data in the second media data in the display page according to the preset cover form;
display the text information in the second media data in the display page according to the preset text display form; and
in response to playing the audio information corresponding to the text information in the second media data, display a first text corresponding to the played audio information in the text information in a first form.

18. The electronic device of claim 11, wherein the one or more programs further cause the one or more processors to:
obtain background media data according to a first style type corresponding to the second media data, the background media data being configured to render background information of the second media data.

19. The electronic device of claim 12, wherein the one or more programs further cause the one or more processors to:
display an audio parameter setting interface in response to a trigger operation on an audio generation control in a first page; and
obtain, in response to an edit operation in the audio parameter setting interface, a quantity range, a first model, a first style type, and fourth media data for configuring at least one first media data in the audio parameter information, wherein the audio parameter setting interface comprises at least one selectable second style type.

20. A non-transitory storage medium comprising computer-executable instructions that, when executed by a computer processor, cause the computer processor to:
display at least one first media data in a display page in response to receiving an operation of configuring the at least one first media data in a media data generation page; and
display second media data in the display page in response to receiving event-related information of the second media data corresponding to the first media data;
wherein the second media data comprises text information and audio information corresponding to the text information, and the text information is related to media content of the first media data.
